(19) United States
(12) Patent Application Publication
(10) Pub. No.: US 2011/0215905 A1
(43) Pub. Date: Sep. 8, 2011

(54) METHOD FOR PROTECTING DATA PRIVACY AND WIRELESS COMMUNICATION SYSTEM

(76) Inventors: Ying-Hong Shen, Taipei Hsien (TW); Yi-Te Huang, Taipei Hsien (TW)

(21) Appl. No.: 13/007,661

(22) Filed: Jan. 16, 2011

(30) Foreign Application Priority Data
Mar. 2, 2010 (TW) 099106039

(51) Int. Cl. G06K 7/01

(52) U.S. Cl. 340/10.1

(57) ABSTRACT

A method for protecting data privacy of a mobile communication device includes detecting whether any RFID tag data is received, determining whether an RFID tag data is equal to a first RFID tag data corresponding to an RFID tag device stored in the mobile communication device when the RFID tag data is received, and prohibiting a specified service of the communication device from being accessed when the RFID tag data is not equal to the first RFID tag data.

### BACKGROUND OF THE INVENTION

1. Field of the Invention

The present invention relates to a method for protecting data privacy and related wireless communication system, and more particularly, to a method for protecting data privacy by using radio frequency identification (RFID) technology and related wireless communication system.

2. Description of the Prior Art

With development of computer technologies and popularity of the wireless communication network, a mobile phone has become a necessity for everyone in modern life, to provide basic communication functions and high-level application services as the Internet, email, and Global Positioning System (GPS), which are common in a mobile phone nowadays. A mobile phone is a private equipment, and if a person who owns a mobile phone loses it or does not carry it along with, the mobile phone may be taken by others and data stored in the mobile phone including personal information, contact lists, emails and pictures may be viewed and utilized by others without the owner's permission. For that reason, the data privacy issue is highly concerned when more and more high-level application services are provided in a mobile phone.

In general, a mobile phone provides one or more passwords set for protecting specific application services and files from being viewed or used, and the user has to input a correct password to unlock the protection so as to access that application services or files. However, it is inconvenient for the user to input passwords over and over when the application services or files that need passwords are frequently accessed. Besides, the user may forget to lock the application services or files, or forget passwords, which causes a risk of data leakage.

From the above, the conventional method of using passwords to protecting data privacy is not convenient and cannot get rid of data leakage because the user has to manually input passwords and may forget to lock the application services or files to be protected.

### SUMMARY OF THE INVENTION

It is therefore a primary objective of the claimed invention to provide a method for protecting data privacy by using RFID technology and related wireless communication system.

An embodiment of the invention discloses a method for protecting data privacy of a mobile communication device includes detecting whether any RFID tag data is received, determining whether the RFID tag data is equal to a first RFID tag data corresponding to an RFID tag device stored in the mobile communication device when the RFID tag data is received, and prohibiting a specified service of the communication device from being accessed when the RFID tag data is not equal to the first RFID tag data.

An embodiment of the invention further discloses a wireless communication system using RFID technology includes an RFID tag device and a mobile communication device. The RFID tag device includes an antenna and a memory coupled to the antenna for storing a first RFID tag data. The mobile communication device includes an RFID reader for determining whether an RFID tag data is equal to the first RFID tag data when the RFID tag data is received, and an operating unit coupled to the RFID reader for prohibiting a specified service of the mobile communication device from being accessed when the RFID tag data is not equal to the first RFID tag data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the invention.

FIG. 2 is a functional block diagram of the wireless communication system in FIG. 1 according to an embodiment of the invention.

FIG. 3 is a flowchart of a process according to an embodiment of the invention.

FIG. 4 is a functional block diagram of a wireless communication system according to an embodiment of the invention.

FIG. 5 is a flowchart of a process according to an embodiment of the invention.

### DETAILED DESCRIPTION

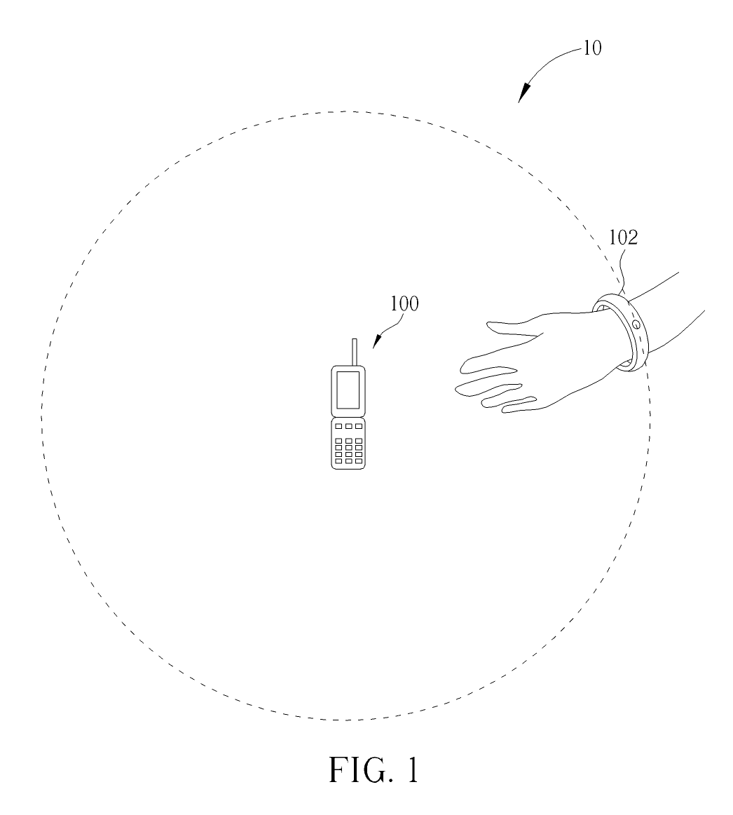

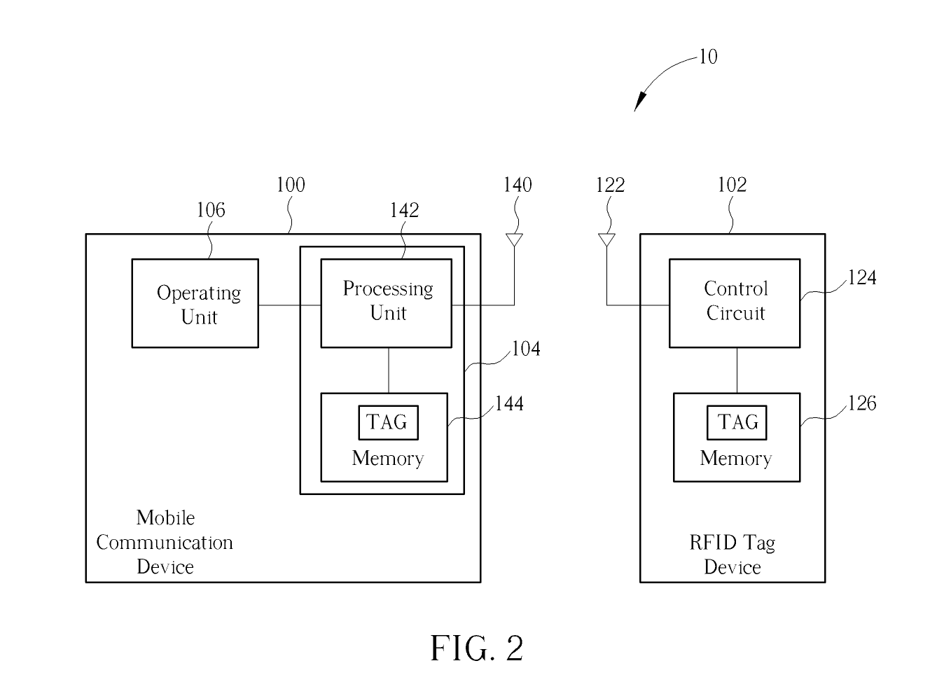

An embodiment of the invention uses Radio Frequency Identification (RFID) technology to protect data privacy of a mobile communication device. Please refer to FIG. 1 and FIG. 2. FIG. 1 is a diagram of a wireless communication system 10 according to an embodiment of the invention, and FIG. 2 is a functional block diagram of the wireless communication system 10. The wireless communication system 10 is a system that RFID technology is applied to, and comprises a mobile communication device 100 and an RFID tag device 102. The mobile communication device 100 comprises an RFID reader 104 and an operating unit 106, and can be a mobile phone, personal digital assistant, mobile internet device and so on. The RFID reader 104 comprises an antenna 140, a processing unit 142, and the memory 144. The processing unit 142 is coupled to the antenna 140, the memory 144, and the operating unit 106, and is utilized for performing core RFID functions. The operating unit 106 controls operations of the mobile communication device 100, responsible for handling all the application programs and commands assigned by a user of the mobile communication device 100.

The RFID tag device 102 is a device dedicated to be used for the user of the mobile communication device 100, and is used only with the mobile communication device 100. The RFID tag device 102 can be a bracelet, as shown in FIG. 1, or any other object that is easily carried along with the user, e.g. a card or a key. The RFID tag device 102 comprises an antenna 122, a control circuit 124, and a memory 126. The memory 126 stores an RFID tag data, denoted as TAG in FIG. 2. The control circuit 124 is coupled to the antenna 122 and the memory 126. When the antenna 122 receives radio signals from the air and thereby a current is generated in the RFID tag device 102, the control circuit 124 obtains the RFID tag data TAG from the memory 126, and transmits the RFID tag data TAG to the air through the antenna 122. Note that, during the initialization of the RFID tag device 102, the RFID tag device 102 first sends the RFID tag data TAG to the mobile communication device 100; after the mobile communication device 100 identifies the RFID tag device 102, the RFID tag data TAG is also stored in the memory 144 of the RFID reader 104.

According to characteristics of RFID technology, when the distance between the RFID tag device 102 and the RFID reader 104 is within the reading distance, the electromagnetic field generated by the antenna 140 when transmitting radio signals induces a current in the antenna 122 of the RFID tag device 102 to activate the RFID tag device 102, so that the RFID tag device 102 transmits the RFID tag data TAG stored in the memory 126 to the RFID reader 104. Otherwise, when the distance between the RFID tag device 102 and the RFID reader 104 is larger than the reading distance, the RFID reader 104 does not receive the RFID tag data TAG of the RFID tag device 102. The invention uses the characteristic as the above to protection privacy of data and application services in the mobile communication device 100

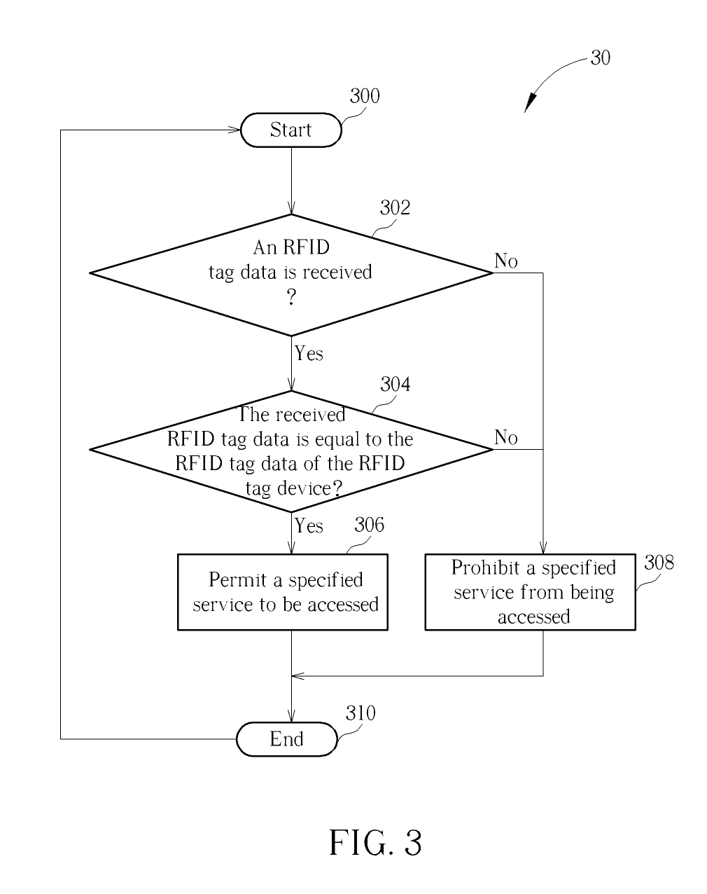

Please refer to FIG. 3, which is a flowchart of a process 30 according to an embodiment of the invention. The process 30 is utilized in the mobile communication device 100 in the wireless communication system 10 to protect privacy of data or application services. The process 30 includes the following steps:

Step 300: Start.

Step 302: Detect whether any RFID tag data is received. If an RFID tag data is received, perform Step 304; else, perform Step 308.

Step 304: Determine whether the received RFID tag data is equal to the RFID tag data TAG of the RFID tag device 102. If the received RFID tag data is equal to the RFID tag data TAG, perform Step 306; else, perform Step 308.

Step 306: Permit a specified service of the communication device 100 to be accessed.

Step 308: Prohibit a specified service of the communication device 100 from being accessed.

Step 310: End.

Please note that there may be many RFID tag devices in the surroundings of the mobile communication device 100, which may not be related to the mobile communication device 100 and may be used with other mobile communication devices. Generally, operating frequency of the RFID reader 104 and the RFID tag device 102 is in ultra-high frequency (UHF), 902-928 MHz, and the reading distance reaches 5 meters.

Step 302 is periodically performed. The processing unit 142 of the RFID reader 104 periodically detects whether any RFID tag data is received by every 30 seconds or 1 minute for example, which is defined by the mobile communication device 100. When the RFID reader 104 does not receive any RFID tag, it is known that there is no RFID tag device within the reading distance and therefore the mobile communication device 100 is not carried along with the user or putted within the line of sight. In this situation, according to Step 308, the operating unit 106 of the mobile communication device 100 prohibits a specified service from being accessed, that is, the operating unit 106 locks the specified service. Even though others obtain the mobile communication device 100, they have no way to unlock the specified service by passwords manually inputted; only the person who carries the RFID tag device 102 has authority to unlock the specified service by the RFID tag device 102. Note that which service necessary to be locked, such as browsing/editing/sending emails or browsing specific folders, is decided by the user of the mobile communication device 100.

After the antenna 140 of the RFID reader 104 receives an RFID tag data, the processing unit 142 compares the received RFID tag data and the RFID tag data TAG stored in the memory 144, to determine whether the received RFID tag data is equal to the RFID tag data TAG. That is, to determine whether the received RFID tag data is transmitted from the RFID tag device identified by the mobile communication device 100. When the processing unit 142 determines that the received RFID tag data is equal to the RFID tag data TAG, which implies that the RFID tag device 102 is located within the reading distance of the RFID reader 104 and the mobile communication device 100 is located within the line of sight of the user, such as a range of 5 meters around, the mobile communication device 100 has less possibility to be taken away by other person. In this situation, the processing unit 142 notifies the operating unit 106 to permit a specific service to be accessed without inputting passwords. Therefore, the inconvenience resulted from manually inputting passwords to unlock the specific service is reduced. When the processing unit 142 determines that the received RFID tag data is not equal to the RFID tag data TAG, which implies that the RFID tag device 102 is not located within the reading distance of the RFID reader 104, the processing unit 142 notifies the operating unit 106 to prohibit the specific service from being accessed so as to protect data privacy of the specific service.

From the above, when the mobile communication device 100 is collaborated with the RFID tag device 102, data privacy of the mobile communication device 100 is well protected. The RFID tag device 102 is convenient and easy to carry, and the user does not require memorizing passwords and repeatedly doing lock/unlock operation by using passwords. In the prior art, it is a trouble for the user that when the mobile communication device is taken away, passwords for locking specific services or folders may be cracked, which results in data leakage. In comparison, the user has no worry about data leakage when the mobile communication device 100 is taken away by others because the mobile communication device 100 uses the RFID tag device 102 to protect data privacy instead of passwords.

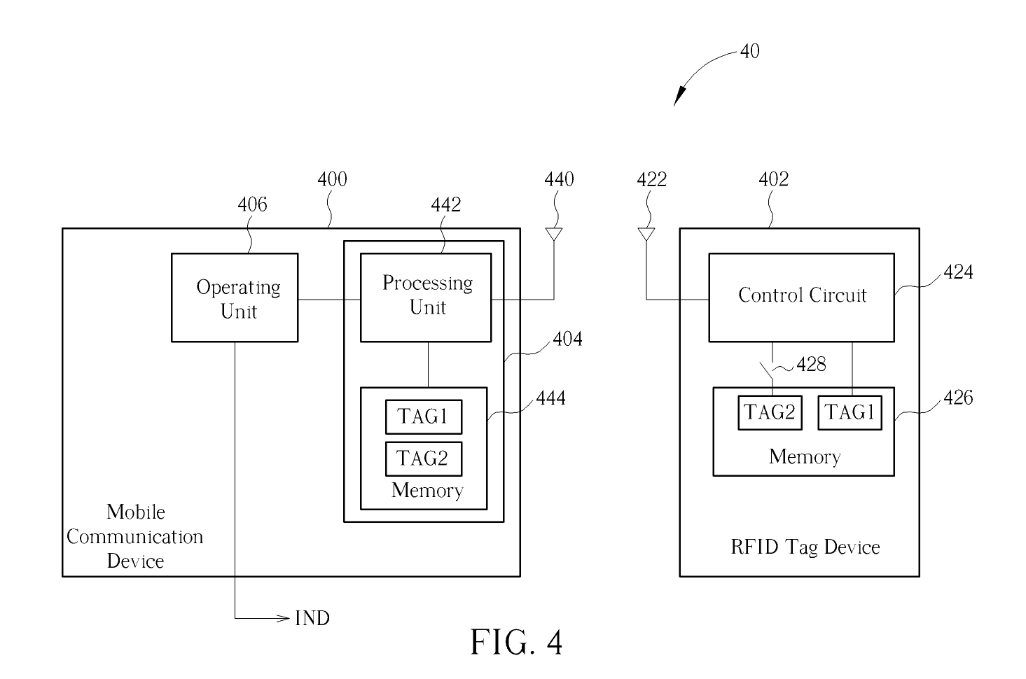

The RFID tag device 102 is modified for further applications according to the invention. For example, when the mobile communication device 100 is lost, the user can find the mobile communication device 100 as soon as possible with the aid of the RFID tag device 102, so that data privacy of the mobile communication device 100 is also protected. Please refer to FIG. 4, which is a functional block diagram of a wireless communication system 40 according to an embodiment of the invention. The wireless communication system 40 comprises a mobile communication device 400 and an RFID tag device 402. The mobile communication device 400 comprises an RFID reader 404 and an operating unit 406. The RFID reader 404 comprises an antenna 440, a processing unit 442, and a memory 444. The RFID tag device 402 comprises an antenna 422, a control circuit 424, a memory 426, and a switch 428. The memory 426 is utilized for storing RFID tag data TAG1 and TAG2. The switch 428 is coupled between the memory 426 and the control circuit 424, installed in a position where the user can easily control the on/off state of the switch 428, as a button outside the RFID tag device 402 for example. The switch 428 is utilized for controlling transmission of the RFID tag data TAG2, and the default state of the switch 428 is the off state. When the RFID tag device 402 is identified by the mobile communication device 400, the RFID tag data TAG1 and TAG2 are also transmitted to the mobile communication device 400 and stored in the memory 444 of the RFID reader 404.

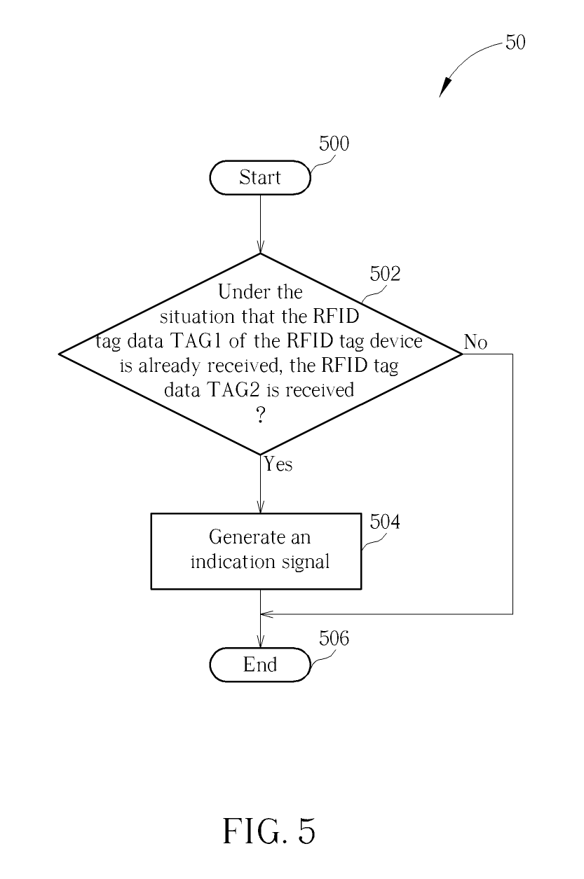

The utility of the RFID tag data TAG1 is the same as the RFID tag data TAG shown in FIG. 2, which is used for protecting data privacy of the mobile communication device 400. The RFID tag data TAG2 is utilized as a request to ask the response of the mobile communication device 400, for obtaining the location of the mobile communication device 400. Note that the process 30 of FIG. 3 can also be utilized in the mobile communication device 400. Please refer to FIG. 5, which is a flowchart of a process 50 according to an embodiment of the invention. The process 50 is utilized in the mobile communication device 400 for indicating the location of the mobile communication device 400. The process 50 comprises the following steps:

Step 500: Start.

Step 502: Under the situation that the RFID tag data TAG 1 of the RFID tag device 402 is already received, detect whether the RFID tag data TAG2 is received. If the RFID tag data TAG2 is received, perform Step 504; else, perform Step 506.

Step 504: Generate an indication signal.

Step 506: End.

According to the process 50, the processing unit 442 of the mobile communication device 400 detects whether the RFID tag data TAG2 is received under the situation that the RFID tag data TAG 1 of the RFID tag device 402 is already received, which implies that the RFID tag device 402 is identified by the mobile communication device 400. When the processing unit 442 detects the RFID tag data TAG2, which indicates that the user turns on the switch 428 of the RFID tag device 402 in order to find the mobile communication device 400 and the distance between the RFID tag device 402 and the mobile communication device 400 is within the reading distance of the RFID reader 404, the processing unit 442 controls the operating unit 406 to generate an indication signal IND, e.g. audio signal as ringing signal, light signal as flashlight, or vibration signal, to indicate the location of the mobile communication device 400. Therefore, when the mobile communication device 400 is temporary lost, the user simply turns on the switch 428 and quickly finds the mobile communication device 400 through the indication signal IND. In practice, when the mobile communication device 400 is a mall-size mobile phone, benefit from the process 50, the user can quickly find the small-size mobile phone when in a hurry, so that the data privacy of the mobile phone is well protected.

In conclusion, according to the invention, the specific service in a mobile communication device is prohibited from being accessed or allowed to be accessed according to whether the RFID reader of the mobile communication device receives the RFID tag data of the RFID tag device dedicated to the mobile communication device, and therefore data privacy of the mobile communication device is protected. Furthermore, the RFID tag device capable of transmitting one more RFID tag data provides the function of finding the lost mobile communication device, which also reduces the possibility of data leakage and thereby improve data privacy.

Those skilled in the art will readily observe that numerous modifications and alterations of the device and method may be made while retaining the teachings of the invention.

What is claimed is:

1. A method for protecting data privacy in a mobile communication device comprising:
detecting whether any radio frequency identification (RFID) tag data is received;
when an RFID tag data is received, determining whether the received RFID tag data is equal to a first RFID tag data corresponding to an RFID tag device stored in the mobile communication device; and
when the received RFID tag data is not equal to the first RFID tag data, prohibiting a specified service of the communication device from being accessed.

2. The method of claim 1 further comprising:
when the received RFID tag data is equal to the first RFID tag data, permitting the specified service of the communication device to be accessed.

3. The method of claim 1 further comprising:
when no RFID tag data is received, prohibiting the specified service of the communication device from being accessed.

4. The method of claim 1 further comprising:
Under the situation that the first RFID tag data is already received, when receiving a second RFID tag data corresponding to the RFID tag device, generating an indication signal.

5. The method of claim 4, wherein the indication signal is an audio signal, a light signal, or a vibration signal.

6. A wireless communication system using radio frequency identification (RFID) technology comprising:
an RFID tag device comprising an antenna and a memory coupled to the antenna for storing a first RFID tag data; and
a mobile communication device comprising:
an RFID reader for determining whether an RFID tag data is equal to the first RFID tag data when the RFID tag data is received; and
an operating unit coupled to the RFID reader for prohibiting a specified service of the mobile communication device from being accessed when the RFID reader determines that the RFID tag data is not equal to the first RFID tag data.

7. The wireless communication system of claim 6, wherein the operating unit of the mobile communication device permits the specified service of the mobile communication device to be accessed when the RFID reader determines that the RFID tag data is equal to the first RFID tag data.

8. The wireless communication system of claim 6, wherein the RFID tag device comprises a switch coupled between the antenna and the memory.

9. The wireless communication system of claim 8, wherein the memory stores a second RFID tag data that is transmitted to the mobile communication device when a current is generated in the RFID tag device and the switch is turned on.

10. The wireless communication system of claim 9, wherein the mobile communication device generates an indication signal when receiving the second RFID tag data under the situation that the first RFID tag data is already received.

11. The wireless communication system of claim 10, wherein the indication signal is an audio signal, a light signal, or a vibration signal.
